(19) United States
(12) Patent Application Publication
(10) Pub. No.: US 2024/0098515 A1
(43) Pub. Date: Mar. 21, 2024

(54) Automated Orienting of Customer Premises Equipment

(71) Applicant: AT&T Intellectual Property I, L.P., Atlanta, GA (US)

(72) Inventors: Yizhe Zhang, Austin, TX (US); Yupeng Jia, South Pasadena, CA (US)

(21) Appl. No.: 17/945,424

(22) Filed: Sep. 15, 2022

(51) Int. Cl. H04W 16/20; H04W 64/00

(52) U.S. Cl. CPC H04W 16/20; H04W 64/003

(57) ABSTRACT

Automated orienting of customer premises equipment (CPE) is disclosed. An orientation of a CPE can be automatically adapted based on a model of an environment of the CPE, an environmental condition, etc. Adapting an orientation can change roll, pitch, yaw, and skew of a whole CPE, and/or a portion of the CPE. In embodiments, a CPE can perform exploratory orienting to update a mapping of the environment of the CPE. This can enable the CPE to rank, sort, order, etc., alternate orientations to satisfy one or more rules related to operation of the CPE. This can facilitate the CPE mitigating a hazard condition, altering a performance metric, accommodating a customer preference, etc. In embodiments, a learning component can be employed to predict a preferred adjustment to an orientation based on user input, a rule, historical condition information, contemporaneous condition information, etc.

### TECHNICAL FIELD

The disclosed subject matter relates to customer premises equipment (CPE) for a wide area network and, more particularly, to automated orienting of CPE.

### BACKGROUND

Conventional customer premises equipment (CPE) at the edge of a network, such as a cellular network, etc., is typically statically positioned. Generally, a CPE can support 4G, 5G, WiFi, fiberoptic, or other links between a user equipment (UE) and a network of a network provider entity. CPEs are typically of a small form factor and can be placed in a customer premises. The placement of a CPE is typically static, although a customer can, on occasion, move the CPE to another static position. As an example, a customer can place a CPE that uses a 5G interface to a UE, and a microwave interface to a wireless network of a wireless network operator, on a windowsill in a home. This example placement can be unlikely to change without intervention of the customer. A typical CPE can comprise many antennas, with numerous available CPEs already comprising 15 or more antennas in a single CPE. Optimal placement of the CPE is generally difficult to achieve, can be subject to change as an environment evolves, and can conflict with a placement choice preferred by a customer. Accordingly, conventional CPEs can often have sub-optimal placements, which can result in corresponding sub-optimal performance, exposing the CPE to potential damage, etc. As an example, a customer can place a CPE in a closet to keep it out the design aesthetic of their premises, which can result in reduced signal strength due to walls, doors, clothing, wiring, plumbing, etc., that can be located between the CPE and a UE and/or network component. Moreover, the example closet placement can lack airflow that can result in the CPE experiencing insufficient cooling that can lead to actual damage to the CPE components, can cause the CPE to power cycle and/or throttle performance to mitigate heat load that can affect connectivity to UEs/networks, or other undesirable affects. In another example, customer placement of a CPE near a window in a commercial office can expose the CPE to solar radiation that can result in an excessively warn condition for the CPE. In a still further example, a CPE can be placed in a portion of a structurally significant portion of an office, such as in an elevator core region, that can have significantly more reinforcing bar and concrete than another portion of the office, wherein the placement can experience much more signal attenuation than other portions of the office. It becomes readily apparent that the inability of conventional CPEs to automatically alter their orientation in a customer premises environment can be problematic.

### BRIEF DESCRIPTION OF DRAWINGS

FIG. 1 is an illustration of an example system that can facilitate automated orienting of customer premises equipment (CPE), in accordance with aspects of the subject disclosure.

FIG. 2 is an illustration of an example system that can facilitate automated orienting of CPE based on a modeling of an environment of the CPE, in accordance with aspects of the subject disclosure.

FIG. 3 is an illustration of an example system that can enable automated orienting of CPE via motive component(s) of the CPE, in accordance with aspects of the subject disclosure.

FIG. 4 illustrates an example system that can facilitate automated orienting of CPE that can improve performance via reorienting the CPE relative to an environmental attenuator, in accordance with aspects of the subject disclosure.

FIG. 5 illustrates an example system that can employ automated orienting of CPE that can improve performance via reorienting the CPE relative to an environmental hazard, in accordance with aspects of the subject disclosure.

FIG. 6 is an illustration of an example method enabling automated orienting of CPE, in accordance with aspects of the subject disclosure.

FIG. 7 illustrates an example method, enabling automated orienting of CPE by moving a portion of the CPE in accord with a model of a CPE environment, in accordance with aspects of the subject disclosure.

FIG. 8 illustrates an example method, facilitating automated orienting of CPE in response to a learning component initiating a reorienting of the CPE, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As noted above, conventional customer premises equipment (CPE) are typically statically positioned. CPEs can support 4G, 5G, WIFI, fiberoptic, or other links between a user equipment (UE) and a network, such as a wireless network of a wireless network provider. CPEs are typically of a small form factor, can be placed in a customer premises, and can comprise many transmit/receive (TX/RX) antennas in a single CPE. While a placement of a CPE can typically be considered static, on occasion, a customer can move a CPE to another static position, e.g., CPE placement is unlikely to change without intervention of a customer. Issues with static placement can include a placement of the CPE that is typically not optimal, a good placement can be subject to change as an environment evolves, a good placement can conflict with a customer's preferred placement for the CPE, etc. Accordingly, conventional CPEs can often have sub-optimal placements and corresponding sub-optimal performance, a CPE can be exposed to potentially damaging conditions, etc. It is therefore desirable to enable automatic orientation for CPEs to improve CPE performance, protect CPEs, better satisfy customer placement goals for a CPE, etc.

An embodiment of the disclosed subject matter discloses automating CPE orienting, which can include initial orienting of a CPE, reorienting of a CPE, etc., that can alter a performance of a CPE, alter a hazard experienced by a CPE, adapt a CPE orientation relative to a customer preference, etc. In embodiments, a portion of a CPE can undergo an automatic orientation operation. This can include translation, rotation, etc., of the portion of the CPE. The portion of the CPE can be the whole CPE, can be less than the whole CPE, etc. As an example, a CPE can be translated from a first location to a second location, such as by driving, crawling, hovering, flying, dragging, etc., the CPE from the first location to the second location. In some embodiments, this example can be inclusive of moving the CPE between different customer premises or portions of a customer premises, for example between two buildings, between to offices, between two rooms, between the inside and outside of a home/office, etc. In another example, automated orienting of a CPE can comprise rotating, pitching, rolling, etc., the whole CPE in a same location. In a further example, a portion of a CPE, for example an antenna, a component sunshield, a battery, a processor, etc., can be translated, rotated, pitched, rolled, etc., for example to move a processor from a sunnier side of the CPE to a less sunny side of the CPE to reduce heat loading of the processor, etc. Moreover, embodiments of the disclosed automated orienting subject matter can comprise orienting both the whole CPE and orienting one or more portions of the CPE. As an example, a CPE can be driven from a first location behind a customer premises wall to a second position near a window in the wall, can telescope an antenna mast, e.g., translating a portion of the CPE, and can rotate and tilt a sunshield of the CPE, which is now in front of a window in this example, to block sun entering the window and impinging on the CPE. This example, demonstrate corpus and pars corpus motive operations for both the whole CPE and portions of the CPE. In this example, the orienting can be responsive to a performance metric, such as a signal strength, throughput, latency, bandwidth, etc., e.g., driving the CPE from the first to the second position and telescoping the antenna mast can improve signal strength by repositioning the CPE from behind the wall to an open window with fewer obstructions between a CPE antenna and a RAN device. Moreover, in this example, the orienting of the sunshield can reduce thermal loading on the CPE that has moved from behind a wall to in front of a window where it can be more exposed to incoming g sunlight.

In embodiments, automated orienting of to CPE can be based on mapping of an environment of the CPE. A map of the environment can be received by the CPE, e.g., provided to the CPE. Moreover, the CPE can map the CPE, for example via a sensor, imager, etc. As examples, a map of the CPE environment can be determined from images of the environment taken by an imaging component of the CPE, can be a signal strength map determined by signal strength measurements taken by the CPE, can be a thermal map determined via an infrared sensor of the CPE, etc. Moreover, the CPE can undergo reorienting as part of determining a map, updating a mapping, etc. In an example, a CPE can rotate an antenna array to map radio frequency (RF) key performance indicators (KPI) to different orientations of the antenna array. Similarly, the CPE can be incrementally translated, e.g., driven around a room, to map KPIs. In another example, a CPE can map the CPE being manually moved, such as by a customer physically moving the CPE, etc., when the CPE is in some orientation, e.g., if the CPE moves into the middle of the room to get better signal and a customer moves the CPE into the corner to get it out of the way, the CPE can map the center of the room as an ‘exclusion area’ to reflect that moving to that area can result in an external reorientation occurrence.

In embodiments, mapping, customer preferences, environmental conditions can be employed by an artificial intelligence (AI) component, machine learning (ML) component, etc., hereinafter a learning component (LC), etc., that can perform a learning operation(s), etc. In this regard an LC can be used to predict a preferred orientation, e.g., an orientation that can balance one or more of a KPI, environmental hazard, operating condition, customer preference, etc. In an example, a CPE can fly from a floor position to a hover position in front of a window to improve signal strength at the cost of consuming energy from a battery to fly the CPE to that position, whereby this orientation (hovering in front of the window) can be determined by a learning component to be preferable where the battery is above a threshold energy level and where data traffic via the CPE is indicated as favoring the example improved signal strength corresponding to the hover. As such, in this example, the CPE can remain on the floor, for example in a charging cradle, for most data traffic conditions, but can then go into the hover orientation when the data traffic is determined to favor the improved signal strength and where the CPE drone is sufficiently charged up. The use of a learning component can ‘learn’ combinations of conditions where changing orientation of the CPE is sufficiently desirable to initiate the automatic orienting of the CPE. As an example, and factory can batch upload process line data at a fixed time every day, wherein moving a CPE from a first location to a second location improves KPIs resulting in better commination of the batched process line data but also results in the CPE being exposed to a heat source in the factory that stresses the CPE components. In this example, a learning component can determine that moving to the second location for just long enough to upload the batched process line data minimizes thermal stress on the CPE. Accordingly, the CPE can be automatically reoriented to the second position just prior to the example fixed time to accommodate the batch process line data upload and then automatically be moved back to the first position to reduce thermal stressing of the CPE at the conclusion of the batch process line data upload. It is noted that in some embodiments, the learning component can further ‘explore’ other locations that, for example, can provide the improved KPIs with less thermal stress, etc., e.g., the CPE can be automatically reoriented in response to control by a learning component to map by exploration another orientation that may be favorable to both the first and second positions in this example. Where, in this example, a third location is discovered by the learning component that provides adequate KPIs and acceptable thermal conditions, the CPE can be automatically reoriented to the third location in lieu of moving between the first and second locations. Moreover, where conditions change relative to the example third location, for example an attenuator being moved proximate to the third location, the learning component can automate reverting orientation back to the first location with periodic reorientation to the second location. Expanding this example, where the batched process line data begins employing a data compression operation, thus reducing the need for the improved KPI location, the learning component can determine that remaining in the first location is adequate and can abort further periodic reorienting to the second orientation.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

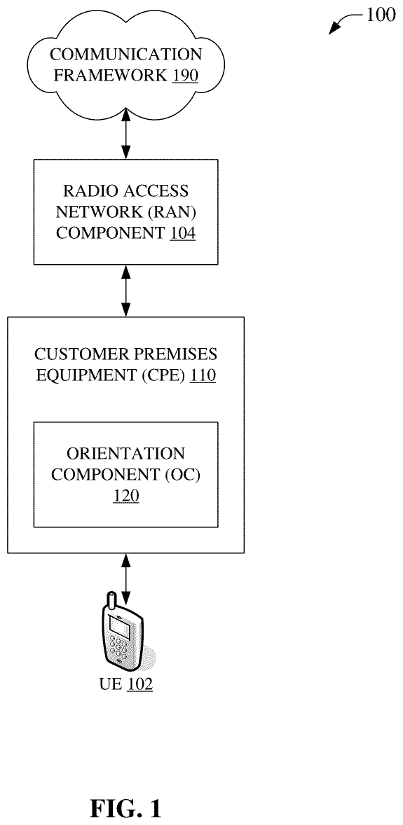

FIG. 1 is an illustration of a system 100, which can facilitate automated orienting of customer premises equipment (CPE), in accordance with aspects of the subject disclosure. System 100 can comprise CPE 110 that can facilitate communication between a user equipment (UE), e.g., UE 102, etc., and a radio access network (RAN) component, e.g., RAN component 104, etc. In this regard, CPE 110 can be located at a customer premises and can bridge communication between UE 102 and another remotely located end point device, such as a remotely located server, another remotely located UE, etc., typically via RAN component 104 and communication framework 190, e.g., a wireless network such as can be supported by a wireless network operator. As an example, CPE 110 can be located in a customer's home and can connect a cell phone to macro-level wireless network provided by a mobile network operator, enabling communication via a backhaul network comprised in communication framework 190 towards another end point device located remotely from the cell phone at the customer's home. In some embodiments, CPE 110 can also support communication between local UEs, for example, a first UE can communicate with another local UE via CPE 110, however, in these circumstances, connection between CPE 110 and RAN component 104 can be unnecessary. In some embodiments, communication between local UEs can comprise a connection between CPE 110 and RAN component 104, for example, a first UE can communicate to CPE 110 that can communicate to RAN component 104, which can communicate to communication framework 190, for example to a network component of a carrier network, then back to a CPE 110, for example via another RAN component, and to a second UE located locally with the first UE.

CPE 110 operations can comprise selecting an operating frequency, TX/RX hardware, such as antennas, etc., or other connection modalities, for example a fiber optical connection, etc. These operations can support a connection between UE 102 and CPE 110, for example a WIFI connection, a near-filed communication protocol, a BLUETOOTH connection, a cellular connection, etc. These operations can also support a connection between CPE 110 and RAN 104, for example a cellular connection, a fiber optical connection, or other wired or wireless connection modality. CPE 110 can then check environmental conditions relative to CPE 110, for example a thermal check, signal strength or other KPI, motion sensing, spurious radio interference check, etc. Examples of KPIs can comprise reference signals received power (RSRP), reference signal received quality (RSRQ), latency, jitter, bandwidth, throughput, etc. In some embodiments, KPIs can be direct measurements, e.g., signal strength, while other KPIs can be computed, for example, RSRQ can be based on a received signal strength indicator (RSSI) and a number of used resource blocks (N), wherein RSRQ=(N*RSRP)/RSSI measured over a same bandwidth. In this regard, RSRQ can be a carrier-to-interference type of measurement that can indicate a quality of a received reference signal. The RSRQ measurement can provide additional information when an RSRP value can be insufficient to make a reliable decision in some circumstances.

In embodiments, environmental condition information can be employed by orientation component (OC) 120 to determine orienting of a portion of CPE 110, wherein a portion of CPE 110 can be all of CPE 110, e.g., a corpus motive operation, or less than all of CPE 110, e.g., a pars corpus motive operation. It is noted that orienting can result in translating, rotating, etc., of the portion of CPE 110, e.g., the portion of CPE 110 can be moved, rotated, yawed, rolled, rotated, etc., typically in up to six degrees of freedom. The six degrees of freedom can typically be roll, pitch, yaw, skew up/down, skew left/right, and skew forward/backward. Moreover, orienting CPE 110 can comprise orienting more than one portion of CPE 110. As an example, an orientation of all of CPE 110 can altered in reference to a first six degrees of freedom in conjunction with an orientation of another portion of CPE 110, such as an internal thermal shield of CPE 110, being altered in reference to a second six degrees of freedom. This example can be illustrated by moving CPE 110 from a first location to a second location while also rotating an internal thermal shield of CPE 110 from a first position to a second position, e.g., CPE 110 can be moved while the internal thermal shield is also repositioned. In another example, CPE 110 can move from a first to a second location, an antenna mask can be raised, and a solar reflector can be repositioned, which can be regarded as up to 18 degrees of freedom for the change in orientation of CPE 110 in this example, e.g., six for moving the CPE, six for extending the mast, and another six for repositioning the solar reflector. OC 120 can generate orienting information that can result in CPE 110 initiating automatic orienting in accordance with the orienting information. It is noted that automatic orienting can encounter conditions that prevent fully adopting a determined orientation, for example, where the OI ideally causes CPE 110 to move from one side of a room to the other, the CPE 110 can encounter an impediment, e.g., furniture, thick carpeting, a step, etc., that can prevent CPE 110 from reaching the opposite side of the room in this example.

In embodiments, OC 120 can learn from orienting failures. In the above example, information about CPE 110 encountering an impediment when migrating across the room can be added to a mapping of the environment of CPE 110. In some embodiments, OC 120 can attempt alternate operations in an effort to achieve an orienting goal and can ‘learn’ via this process. Continuing the above example, where the example impediment can be a heavy rug in the middle of the room, OC 120 can provide alternative corpus motive instructions that cause CPE 110 to ‘explore’ the boundary of the impediment, for example moving to the left four inches, then forward four inches then right four inches in an attempt to bypass the example rug. Multiple alternatives can be attempted, and results can be used to update a map of the environment of CPE 110. In this regard, it can be expected that some of the edges of the example rug can be mapped, and this information can be used in future automated reorientation of the example CPE 110. Moreover, even where the determined orientation may be unattainable, for example due to impediments, customer's manually moving the CPE during a reorientation, etc., OC 120 can be responsive, e.g., in the above example where a step can be an impediment to moving CPE 110 across the room to a first determined orientation, the step can be mapped, and OC 120 can redetermine second determined orientation that considers the example step impediment to the earlier first determined orientation. In this example, the example second determined orientation can avoid movement across the step, can determine using alternative motive operations to surmount the example step impediment, such as flying over the step rather than driving over the step where flying is available to CPE 110, or can continue to attempt to bypass an impediment, such as exploring alternative paths to reach the example first determined orientation, etc.

In embodiments, automated orienting of CPE 110 via orienting information from OC 120 can include an initial orientation in a customer premises, e.g., a first use of CPE 110 in a new customer premises environment, such as an initial setup of CPE 110. The exploratory operations presently disclosed can be employed to test orientations that can improve performance of CPE 110. As an example, a customer can place CPE 110 against a wall that can contain electrical wiring that results in unfavored KPIs. In this example, OC 120 can cause CPE 110 to rotate in place to determine alternate orientations and corresponding KPIs. Where rotation, in this example, does not cure the unfavored KPIs, OC 120 can cause CPE 110 to move to the left or right along the wall in an exploratory mode, which can result in CPE 110 moving to another portion of the wall that has less obstructive cabling. This, for example, can result in improved KPIs. As the example CPE 110 is moved further along the wall in the exploratory mode, CPE 110 can move into a position in which the wall contains metal heat ducting that again lowers KPIs. Accordingly, in this example, OC 120 can determine that reverting back to the portion of the wall without the heat ducting and with fewer cables is a preferred orientation and can generate orienting information that can cause the example CPE 110 to migrate to that position along the wall. Continuing this example, OC 120 can determine that CPE 110 is being lightly used, for example at 3 a.m. when the customer can be asleep and fewer communications are occurring, which information can be used to trigger further exploration of the customer premises, for example moving further about the room rather than just along the wall to map KPIs. In this example, the customer can awake to find CPE 110 located in the middle of the room in the morning due to that location offering improved KPIs. Where the customer then manually moves CPE 110 back to the wall, OC 120 can map the center of the room as an exclusion zone, e.g., based on CPE 110 being manual moved from a preferred orientation. Accordingly, OC 120 can then determine and attempt another preferred orientation, perform further exploration, etc. In embodiments, customer input can be used to predefine exclusion zones, can set a granularity of exploratory mapping of CPE 110, etc., to reduce conflicts between a customer and CPE 110, via OC 120, attempting reorientations that are disfavored by a customer. As an example, a customer can provide a map, barrier, signal source, that can define exclusion zones, etc., that can keep CPE 110 in one room, out of a hallway, forbid flying or other orienting modalities, etc.

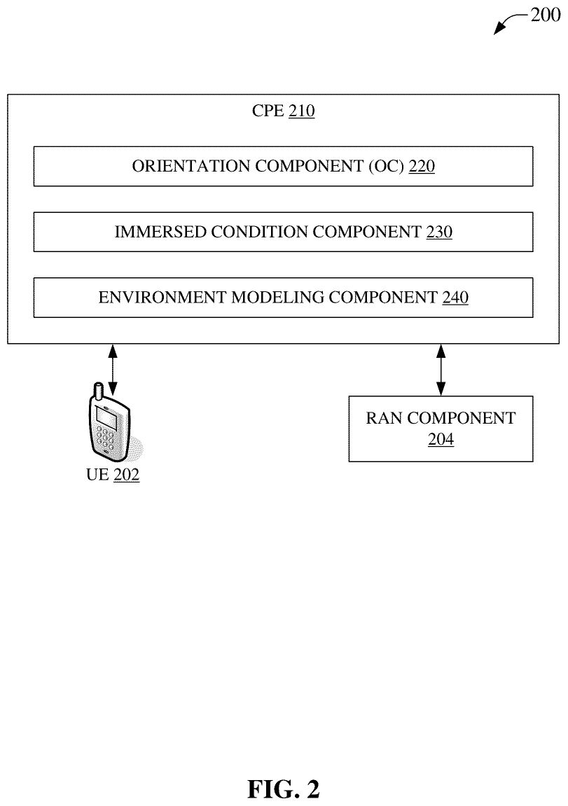

FIG. 2 is an illustration of a system 200, which can enable automated orienting of customer premises equipment (CPE) based on a modeling of an environment of the CPE, in accordance with aspects of the subject disclosure. System 200 can comprise CPE 210 that can facilitate communication between a user equipment (UE), e.g., UE 202, etc., and a radio access network (RAN) component, e.g., RAN component 204, etc. In this regard, CPE 210 can be located at a customer premises and can bridge communication between UE 202 and another end point device via RAN component 204. CPE 210 can select an operating frequency, TX/RX hardware, such as antennas, etc., or other connection modalities to support a connection between UE 202 and CPE 210, and a connection between CPE 210 and RAN 204.

CPE 210 can check environmental conditions, e.g., via immersed condition component 230, for example a thermal check, signal strength or other KPI, motion sensing, spurious radio interference check, etc. As such, CPE 210 can comprise a sensor connected to immersed condition component 230, can be connected to an external sensor, can receive environmental condition information from other devices, etc. In some embodiments, immersed condition component 230 can comprise a sensor. Examples of KPIs can comprise reference signals received power (RSRP), reference signal received quality (RSRQ), latency, jitter, bandwidth, throughput, etc. In an example, CPE 210 can receive temperature information from a processor comprised in CPE 210, can receive thermal image information for a room from a third-party camera with thermal imaging capability, can receive RSSI information from UE 202, etc. In some embodiments, KPIs can be direct measurements, e.g., signal strength, while other KPIs can be computed from other received/determined information. Immersed condition component 230 can therefore provide information related to the operating environment of CPE 210, which can comprise RF information (both signals and spurious/interferer RF information), thermal information, optical/image information such as stationary objects in an environment of CPE 210, motion information such as from objects moving in an environment of CPE 210, audio information that can indicate an event in an environment of CPE 210, etc. As an example, an image of a customers office can indicate furniture/wall locations, people moving about the office, etc., audio information can indicate sounds of employees coughing, typing, etc., which example environmental information can enable immersed condition component 230 to determine that the example office is generally less occupied late at night than during typical business hours, whereby OC 220 can determine to perform exploratory reorienting late at night rather than during typical business hours to avoid impacting customer use of the office. As another example, an image of a customer's office can indicate furniture/wall locations and paths of sunlight through a window, etc., which example environmental information can enable immersed condition component 230 to determine that reorienting CPE 210 from a left side of a window to a right side of a window, while avoiding a desk, around noon can help CPE 210 avoid sitting in a sunbeam and therefore reduce thermal loading. As a further example, received heating schedule information for a customer building can enable immersed condition component 230 to determine that a South facing office of the building is typically hotter than a North facing office in the building, whereby migrating CPE 210 to the North facing office can reduce thermal loading.

In embodiments, environmental condition information can be employed by OC 220 to determine orienting of a portion of CPE 210, wherein a portion of CPE 210 can be all of CPE 210, e.g., a corpus motive operation, or less than all of CPE 210, e.g., a pars corpus motive operation. It is noted that orienting can result in translating, rotating, etc., of the portion of CPE 210, e.g., the portion of CPE 210 can be moved, rotated, yawed, rolled, rotated, etc., typically in up to six degrees of freedom. The six degrees of freedom can typically be roll, pitch, yaw, skew up/down, skew left/right, and skew forward/backward. Moreover, orienting CPE 210 can comprise orienting more than one portion of CPE 210. It is noted that CPE 210 can encounter conditions that prevent fully adopting a determined orientation, for example.

In embodiments, environment modeling component 240 of OC 220 can learn from orienting failures. Where CPE 210 can encounter an impediment during automatic orienting, the impediment can be added to a mapping of the environment of CPE 210. In some embodiments, environment modeling component 240 can provide map information to OC 220 to facilitate achieving an orienting goal by alternate operations, to determine an alternate orienting goal, etc. Accordingly, environment modeling component 240 can receive customer premises mapping information (2-dimensional, 3-dimensional, thermal, RF map, occupancy map, etc.), can receive RAN mapping information, e.g., where is RAN component 204 relative to the customer premises, etc., can self-determine mapping information by exploration, imaging, etc., can update mapping information, or other operations related to modeling an environment of CPE 210, etc. The environmental model/map information from environment modeling component 240 can be employed by OC 220 to determine orienting information that can enable automated orienting of CPE 210. As an example, environment modeling component 240 can determine RF mapping of a customer premises, such as by exploratory reorienting, etc., and can determine locations with favored KPIs and areas with disfavored KPIs, which information can be consumed by OC 220 to enable determining reorienting CPE 210 to a more favorable KPI location. Moreover, immersed condition component 230 can supply historical and contemporaneous environmental condition information that can also be used by OC 220 in selecting a more favorable KPI location relative to environmental conditions. As an example, best KPIs can be directly in front of a large south facing window in a home. However, immersed condition component 230 can indicate that this same location historically receives a lot of solar radiation daily between 10 a.m. and 2 p.m., e.g., in the last week this same location was 40 F hotter during those hours than locations not in front of the South facing window. Accordingly, OC 220 can use the KPI information and the immersed condition information to select automated orienting to move CPE 210 in front of the window only between 6 p.m. and 8 a.m., and to orient to another location between 8 a.m. and 6 p.m.

In embodiments, automated orienting of CPE 210 via orienting information from OC 220 can include an initial orientation in a customer premises, e.g., a first use of CPE 210 in a new customer premises environment, such as an initial setup of CPE 210. The exploratory operations presently disclosed can be employed to test orientations that can improve performance of CPE 210. As an example, a customer can place CPE 210 in a new room and OC 220 can initiate exploratory orienting to enable environment modeling component 240 to build a model of the room. This model of the rom can then be employed by OC 220, via environment modeling component 240, to rank, order, sort, filter, etc., orientations of CPE 210 within the room. Immersed condition component 230 can then provide contemporaneous conditions information that can be used to select a preferred orientation for CPE 210 from among the ranked, sorted, etc., locations derived from the model. A scale of exploration can be selectable by a customer, e.g., a customer can indicate that CPE 210 should stay in the location placed, whereby the exploration can be limited to roll, pitch, and yaw of a portion of CPE 210, such as tilting an antenna array, rotating CPE 210 to move a processor away from a heat vent, rotating an internal sun shield to provide thermal protection, extending a mast to get improved signal strength, etc. Moreover, automated orienting can be performed with one or more levels of granularity, for example, CPE 210 can initially be rotated by 180 degrees to move a processor away from a heat vent, then subsequently rotated (both to the left and/or to the right) by one-degree increments to find a local coolest orientation, e.g., a coarse reorienting stage can be followed by a finer grain orienting stage.

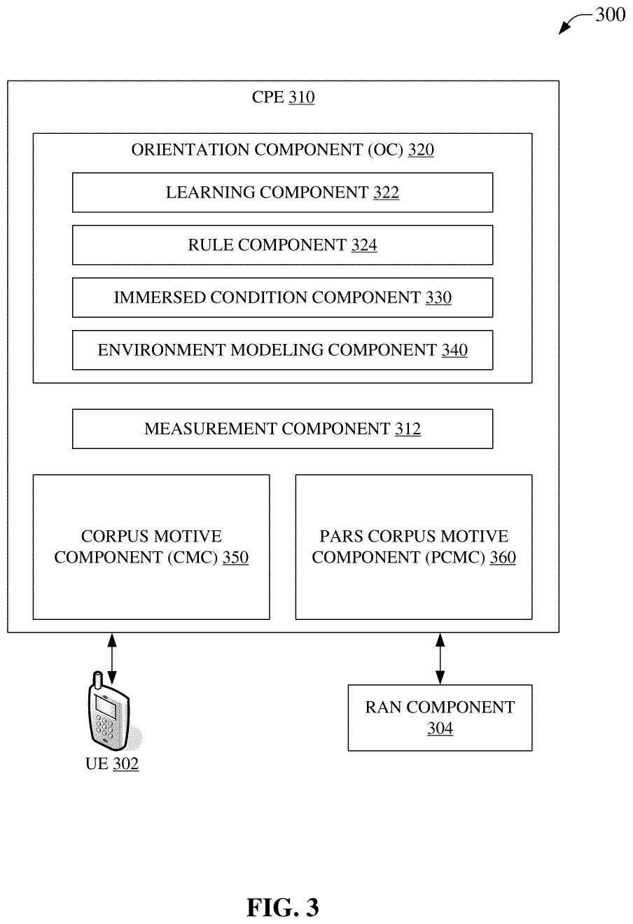

FIG. 3 is an illustration of a system 300, which can facilitate automated orienting of customer premises equipment (CPE) via motive component(s) of a CPE, in accordance with aspects of the subject disclosure. System 300 can comprise CPE 310 that can facilitate communication between a user equipment (UE), e.g., UE 302, etc., and a radio access network (RAN) component, e.g., RAN component 304, etc. In this regard, CPE 310 can be located at a customer premises and can bridge communication between UE 302 and another end point device via RAN component 304. CPE 310 can select an operating frequency, TX/RX hardware, such as antennas, etc., or other connection modalities to support a connection between UE 302 and CPE 310, and a connection between CPE 310 and RAN 304.

Immersed condition component 330 can determine historical and/or contemporaneous environmental conditions. In some embodiment, immersed condition component 330 can predict future environmental conditions, e.g., based on historical and/or contemporaneous conditions, for example, a homeowner can historically turn on air conditioning when a temperature rises above 90 F, which can indicate that a thermostat is set to 90 F, etc., whereby immersed condition component 330 can predict that in the future the homeowner will continue this behavior and that CPE 310 can expect to be in temperatures up to 90 F. In embodiments, CPE 310 can comprise a sensor connected to immersed condition component 330, for example, measurement component 312 can be an optical sensor that can detect movement proximate to CPE 310, which information can be used to delay exploratory orienting in response to detecting movement. In embodiments, CPE 310 can be connected to an external sensor, can receive environmental condition information from other devices, etc. In some embodiments, immersed condition component 330 can comprise a sensor.

In embodiments, environmental condition information can be employed by OC 320 to determine orienting of a portion of CPE 310, wherein a portion of CPE 310 can be all of CPE 310, e.g., a corpus motive operation, or less than all of CPE 310, e.g., a pars corpus motive operation. It is noted that orienting can result in translating, rotating, etc., of the portion of CPE 310, e.g., the portion of CPE 310 can be moved, rotated, yawed, rolled, rotated, etc., typically in up to six degrees of freedom. The six degrees of freedom can typically be roll, pitch, yaw, skew up/down, skew left/right, and skew forward/backward. Moreover, orienting CPE 310 can comprise orienting more than one portion of CPE 310. It is noted that CPE 310 can encounter conditions that prevent fully adopting a determined orientation, for example.

OC 320 can comprise learning component 322 that can employ AI and/or ML techniques to automating orientation of CPE 310. Customer interaction with CPE 310 can indicate preferences or feedback, such as exclusion zones, preferred exploration times, indications of undesirable orienting behavior, etc. As an example, a customer can indicate that CPE is permitted to occupy a single room of a house, which preference can be used to by OC 320, via learning component 322, to learn preferential orientations within the designated room. As another example, CPE 310 can move to a first preferred location, whereupon a customer can manually move CPE 310 to a different location, which can teach OC 320, via learning component 322, that the first preferred location may be less favored by the customer. In this example, repeated removal of CPE 310 from the first preferred location, or other locations proximate to the first preferred location, can teach OC 320 that the first preferred location can be an excluded location, e.g., use of the first preferred location regularly results in manual moving of CPE 310 and therefore the first preferred location should be excluded from selection, etc. Additionally, learning component 322 can employ AI and/or ML techniques to automating orientation of CPE 310 with regard to performance of CPE 310. In this regard, a trigger point causing automated orienting of CPE 310 can be learned via learning component 322. As an example, CPE 310 can be located in a warm area and therefore throttle communication performance to reduced generating excessive heat, but which can also avoid reorienting CPE 310. Where a customer indicates that greater performance is desirable, learning component 322 can learn that it is preferable to reorient than to throttle performance and, accordingly, can decrement a trigger condition threshold that can cause CPE 310 to automatically reorient at a lower temperature to avoid throttling performance. Expanding this example, a customer can take afternoon naps and can indicate that reorienting should not occur during nap time to avoid disturbing the customer's nap. This information can be combined with the above example's threshold modification by learning component 322 to predict a new threshold point that balances not disturbing the customers nap time while also preferably avoiding throttling performance of CPE 310 by causing reorienting from a warm location. Examples of a learned solution can be to throttle performance only slightly at the cost of running at a somewhat elevated temperature, limiting orienting to less disruptive modalities, e.g., roll, pitch, and yaw rather than flying or driving to a new location can be less likely to be disruptive during nap time but can also reduce thermal loading, or preemptive automated reorienting, e.g., moving CPE 310 prior to nap time in expectation of a future thermal event, or other such learned solutions.

In embodiments, rule component 324 can determine a rule related to automating orientation of CPE 310. Rule component 324 can receive a rule, generate a rule, export a rule, etc. In embodiments, rule component 324 can generate a rule based on customer input, for example, a customer can indicate an exclusion zone and rule component 324 can generate a rule excluding the exclusion zone from reorienting operations. Customer input, and/or rules, can be received via a user interface (UX) of CPE 310, via a UX of a mobile device communicatively coupled to CPE 310, via a user profile stored remotely from the customer premises, etc. As an example, a user can input preferences into a web profile, which can be accessed by one or more CPEs, whereby corresponding rule components can determine rules based on the web profile preferences. Moreover, determined rules can be relayed back to the web profile and can be accessed by other CPEs. In this regard, for example, a user can manually move a first CPE which can, via learning component 322 cause a change of behavior that can result in a rule via rule component 324 that can be communicated to the example web profile, whereby a second CPE associated with the web profile can access the new rule and incorporate that rule into orientation of the second CPE. In this example, customer preferences for work CPEs can be related back to home CPEs. It is apparent then, that customer interactions counter to the first CPE rule at the second CPE can result in learning component 322 and rule component 324 maintaining some separate rules and behaviors between the example work and home CPEs, e.g., customer interaction with different CPEs can both cause sharing of rules between CPEs and exclusion of shared rules between CPEs.

In embodiments, environment modeling component 340 of OC 320 can react to orienting failures, e.g., via learning component 322, etc. Where CPE 310 can encounter an impediment during automatic orienting, the impediment can be added to a mapping of the environment of CPE 310, can be considered by learning component 322, can cause generation of a rule via rule component 324, etc. In some embodiments, environment modeling component 340 can provide map information to OC 320 to facilitate achieving an orienting goal by alternate operations, to determine an alternate orienting goal, etc. Accordingly, environment modeling component 340 can receive customer premises mapping information (2-dimensional, 3-dimensional, thermal, RF map, occupancy map, etc.), can receive RAN mapping information, e.g., where is RAN component 304 relative to the customer premises, etc., can self-determine mapping information by exploration, imaging, etc., can update mapping information, or other operations related to modeling an environment of CPE 310, etc. The environmental model/map information from environment modeling component 340 can be employed by OC 320 to determine orienting information that can enable automated orienting of CPE 310. Moreover, immersed condition component 330 can supply historical and contemporaneous environmental condition information that can also be used by OC 320 in selecting a more favorable KPI location relative to environmental conditions. Furthermore, rules from component 324 can be employed by OC 320 in determining a preferred orientation of CPE 310. Similarly, learning component 322 can provide predictions as to which possible orientations will be more preferred. In this regard, environment modeling component 340 can provide a model of an environment for CPE 310, immersed condition component 330 can provide conditions from the environment relevant to determining and/or triggering an automatic reorientation of CPE 310, while rule component 324 can determine if a rule related to reorienting is satisfied, e.g., only orientations satisfying rules can be considered, etc., and learning component 322 can predict, based on AI, ML, etc., techniques which orientation is likely to be preferrable, e.g., ranking, sorting, ordering, etc., of rule abiding possible orientations of CPE 310. This can enable OC 320 to select a preferred orientation and to generate corresponding orientation information.

CPE 310 can comprise corpus motive component (CMC) 350 that can enable orienting of the ‘whole body’ of CPE 310, e.g., orienting of all portions of CPE 310 as compared to orienting a portion of CPE 310, such as a subcomponent of CPE 310, etc., which can be enabled via pars corpus motive component (PCMC) 360. Correspondingly, CPE 310 can comprise PCMC 360 that can enable orienting of the ‘part of the body’ of CPE 310, e.g., orienting of a portion(s) of CPE 310 as compared to orienting a the whole of CPE 310, which can be enabled via CMC 350. CMC 350 and/or PCMC 360 can receive orienting information, e.g., from OC 320. CMC 350 can cause a change in an orientation of CPE 310 based on the orienting information. Similarly, PCMC 360 can cause a change in an orientation of a portion of CPE 310 based on the orienting information. As has been disclosed elsewhere herein, CPE 310, as a whole, can have six-degrees of freedom that can include roll, pitch, yaw, and skew in each of the X, Y, and Z planes. Similarly, orientation of any portion of CPE 310 can also have another six-degrees of freedom that can include roll, pitch, yaw, and skew in each of the X, Y, and Z planes, also as has been disclosed elsewhere herein. In embodiments, automated orienting can comprise orienting of the whole of CPE 310, orienting of a portion of CPE 310, or combinations thereof. As an example, CPE 310 can comprise an antenna array, whereby a final orientation of the antenna array can have 12 degrees of freedom, whereby six degrees are associated with the whole of CPE 310 and another six degrees are associated with the antenna array. In this example, automated orienting can result in moving the whole of CPE 310, including the antenna array, from a first location to a second location, e.g., coarse grain translational movement, and can comprise rotating, tilting, and finer grain translational movement of the antenna array in addition to the moving of the whole of CPE 310. In this example, based on orienting information from OC 320, CMC 350 can cause moving of the whole of CPE 310, while PCMC 360 can cause rotating, tilting, and finer grain translational movement of the antenna array.

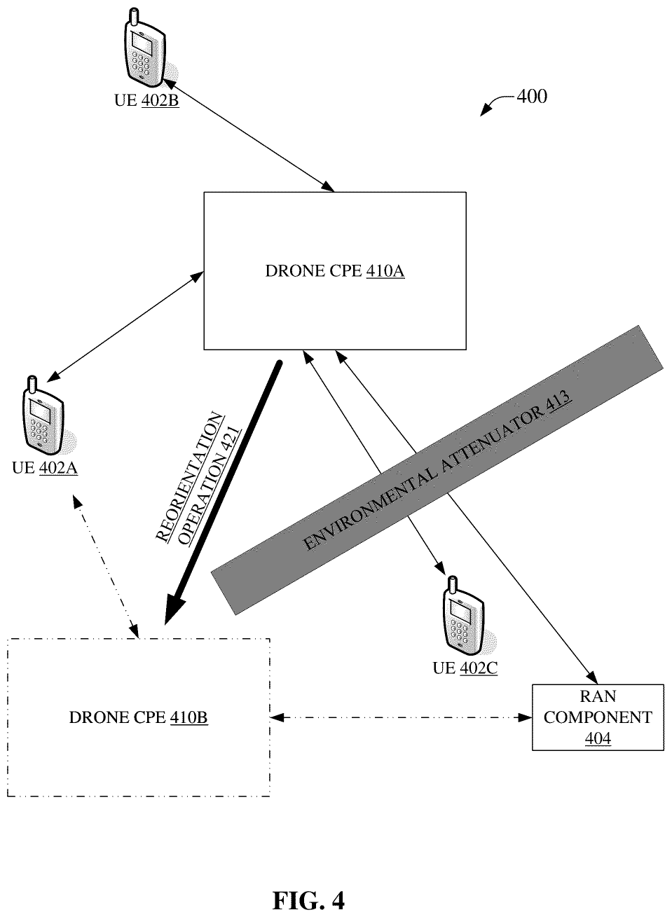

FIG. 4 is an illustration of a system 400, which can enable automated orienting of customer premises equipment (CPE) that can improve performance via reorienting the CPE relative to an environmental attenuator, in accordance with aspects of the subject disclosure. System 400 can comprise drone CPE 410A in a first position that can enable communication between UEs, e.g., UE 402A-C, etc., and RAN component 404. As is illustrated, features of an environment can interfere with wireless communication by injecting RF noise, attenuating a signal etc., which is shown as environmental attenuator 413 in system 400. As examples, environmental attenuator 413 can be a concrete wall, furniture, a source of RF radiation, etc. Accordingly, the signal-to-noise ratio between devices of system 400 can be attenuated. As an example, transmissions between drone CPE 410A and RAN component 404 can be attenuated when passing through environmental attenuator 413. As another example, transmissions between UE 402C and drone CPE 410A can be attenuated when passing through environmental attenuator 413. Generally, a customer premises can comprise many environmental attenuators, for example, walls, elevator shafts, ductwork, cabling, furniture, appliances, etc. In this regard, it can be desirable to orient, or reorient, drone CPE 410A to reduce attenuation of transmitted signals.

Drone CPE 410A can be in a first location at a customer premises. This first location can result in environmental attenuator 413 being located between drone CPE 410A and other devices of system 400, e.g., UE 402C, RAN component 404, etc. As such, reorienting operation 421 can cause automated orienting of drone CPE 410A from the first location to a second location, e.g., illustrated as drone CPE 410B. In this second location at the customer premises, drone CPE 410B can reduce or eliminate attenuation related to environmental attenuator 413. It is noted that reorientation operation 421 can comprise one or more operations selected from roll, pitch, yaw, and skew operations for one or more portions of drone CPE 410A. As an example, drone CPE 410A in a first location can be flown to a second location, e.g., drone CPE 410B. As another example, drone CPE 410A can rotate an antenna array comprised in drone CPE 410E, while drone CPE 410A as a whole can remain in a first location, wherein the resulting drone CPE 410A with a rotated antenna array portion is illustrated as drone CPE 410B, e.g., the CPE can remain in a same location and the antenna can be rotated into a new position that can reduce attenuation from environmental attenuator 413. Numerous other examples of reorienting some portion of drone CPE 410A to drone CPE 410B can be readily appreciated by one of shill in the art and are all considered within the scope of the instant disclosure even where not explicitly described for the sake of brevity.

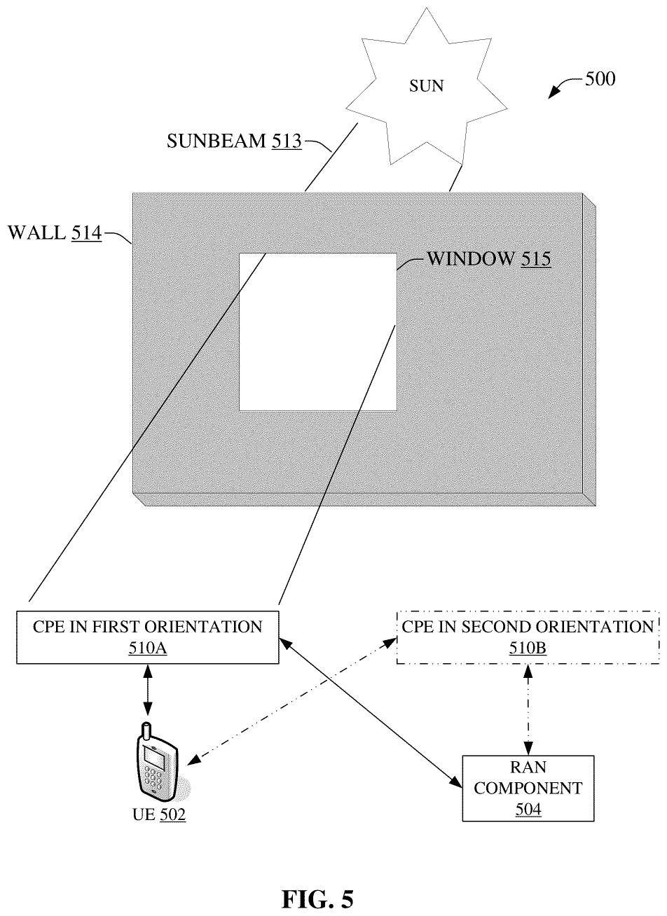

FIG. 5 is an illustration of a system 500, which can facilitate automated orienting of customer premises equipment (CPE) that can improve performance via reorienting the CPE relative to an environmental hazard, in accordance with aspects of the subject disclosure. System 500 can comprise CPE in first orientation CPE 510A, hereinafter CPE 510A for brevity, which can enable communication between UEs, e.g., UE 502, etc., and RAN component 504. As is illustrated, features of a customer premises can present a hazard condition in an environment of CPE 510A, e.g., sunbeam 513 can shine on CPE 510A by passing through window 551 of wall 514. Sunbeam 513 can cause CPE 510A to heat up, in some circumstances to a level that can cause CPE 510A to throttle performance or even shut down to protect components of CPE 510A from thermal damage. In another example, CPE 510A can be located in a poorly ventilated location, such as being in a closet, getting covered by a blanket that can slipped off a couch, being in a dusty corner causing cooling vents of CPE 510A to become increasingly clogged with debris, etc. In this regard, it can be desirable to orient, or reorient, CPE 510A to reduce exposure to a hazard condition, or even a potential hazard condition, of the environment. As an example, it can be desirable to move CPE 510A out of sunbeam 513, e.g., via automated orienting, to mitigate potential overheating effects on CPE 510A.

CPE 510A, or a portion thereof, can be automatically oriented to mitigate potential hazard conditions, such as exposure to sunbeam 513, etc. In this regard, CPE 510A can undergo a reorienting operation(s) resulting in CPE in second orientation 510B, hereinafter simply CPE 510B. In embodiments, automated orienting of CPE 510A can comprise changing any of six degrees of freedom for the whole of CPE 510A, changing any of another six degrees of freedom of a portion of CPE 510A, or combinations thereof. As an example, CPE 510A can undergo self-propelled movement from the first orientation to eh second orientation, e.g., CPE 510A moves to CPE 510B, such as driving CPA 510A out of sunbeam 513, illustrated as CPE 510B. In another example, CPE 510A can comprise a shade component that can be reoriented to reject impinging sunbeam 513. In this example, reorienting the shade component of the CPE to reject more of sunbeam 513 can be represented as transitioning CPE 510A to CPE 510B. Moreover, the whole of CPE 510A can be reoriented in conjunction with reorienting the example shade component of CLE 510A, etc. It is noted that sunbeam 513 can move in time and, as such, automated orienting can correspondingly be repeatedly triggered to continue to reduce exposure of CPE to sunbeam 513. In this regard, CPE 510B can be automatically moved to a third location, the example shade component can be further reoriented, the CPE can be rotated to move heat sensitive components of the CPE into a cooler position, etc.

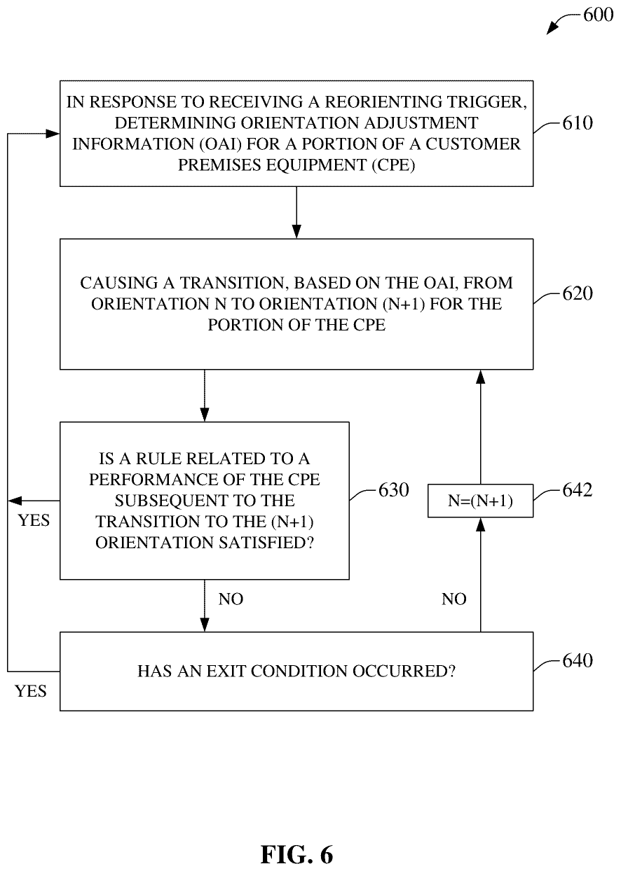

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of example method 600, which can facilitate automated orienting of customer premises equipment (CPE), in accordance with aspects of the subject disclosure. System 600 can comprise determining orientation adjustment information (OAI) for a portion of a CPE. The determining can be in response to receiving a reorienting trigger signal. The reorienting trigger signal can be received from a component of the CPE of from a source external to the CPE. As an example, a processor of the CPE can indicate a temperature, enabling the CPE to determine that a temperature threshold has been traversed, which can trigger the determining the OAI. As another example, a customer can introduce the CPE to a new environment and can trigger an initial orientation, e.g., via a UX of a UE communicatively coupled to the CPE, that can cause method 600, at 610, to determine OAI.

At 620, method 600 can comprise, causing a transition from orientation N to orientation N+1 for the portion of the CPE. The causing the transition can be based on the OAI determined at 610. It is noted that reorientation can be accomplished via a sequence of transitions, for example, moving the CPE from one side of a rom to the other can comprise moving the CPE in stages, such as two units forward, then two units left, then nine units forward, then rotating 180-degrees, etc. In this example, N can be an initial position, and N+1 can be the position after moving two units forward, such that N+2 can be the position after two units forward and two units left, N+3 can be the position after two units forward, two units left, and nine units forward, N+4 can be the position after two units forward, two units left, nine units forward, and rotating CPE 180-degrees. This segmentation of the reorienting operations can facilitate confirmation that each segment of the reorientation has been accomplished. Failure to complete a segment can reveal environmental information that can be used to teach the CPE, for example via a learning component, about the environment and/or conditions of the environment.

Method 600, at 630, can comprise determining that a rule related to a performance of the CPE subsequent to the transition of the N+1 orientation has been satisfied. As an example, where the OAI indicates that reorienting can be accomplished in one segment, such as rotating the CPE to move a processor further from a heat source, etc., then completing the rotation can satisfy a corresponding rule, e.g., method 600 at 630 can indicate ‘yes’ and method 600 can return to 610. As such, after the example rotation has completed, method 600 can await a further reorienting trigger. In this example, if the thermal condition is not resolved by the example rotation of the CPE, then another trigger can be received, and a further reorientation can be determined. Where the rule at 630 is not satisfied, e.g., ‘no’, then method 600 can proceed to 640. As an example, if the CPE fails to rotate to the new orientation in the above example, the rule can be unsatisfied and method 600 can proceed to 640.

At 640, method 600 can determine if an exit condition has occurred. An exit condition can indicate that progression to the new orientation can be truncated. As an example, where in the above example, rotation cannot be completed by the CPE, the exit condition can indicate an impediment to the rotation has occurred, e.g., failed part, physical constraint on the CPE, etc., and method 600 should truncate the reorientation operations. This can result in method 600 returning to 610, e.g., the exit condition returns ‘yes’. However, where the reorienting segmentation comprises, for example, two segments, such as two units forward and two units leftward, then moving two units forward can fail to satisfy a rule related to competing all segments of the reorientation at 630, causing method 600 to enter 640. In this example, testing for an exit condition can return ‘no’ because the first segment (two units forward) has completed. Accordingly, method 600 can advance to 642, where N can be incremented, and then to 620. Method 600 can end at this point. Due to the incrementation of N, the next pass through 620 can cause a transition from N+1 to N+2, based on N=N+1 at 642. In the current example, this can cause the CPE to move two units leftward, subsequent to the previous move two units forward.

Method 600 can then again advance to 630, where the rule, for example, can check for completion of the above example move of CPE two units leftward. Where the move does not complete, 630 can return ‘no’ and method 600 can again move to 640, where the failed move can result in an exit condition, whereby method 600 can return to 610. In this situation, the CPE can receive a further trigger and determine alternate OAI, for example, that can adapt to the failure of the CPE to complete the move of the PCE two units leftward. Moreover, where at 630 it is determined that the leftward move completed, thereby satisfying the example rule, then method 600 can advance to 610. In this situation, the move od the CPE via two orienting segments can be considered complete and the CPE can await a subsequent trigger. Where the successful reorienting resolves a trigger condition, the wait can be until another trigger condition arises. However, where ethe successful reorienting does not resolve the trigger condition, a trigger can be reissued to again attempt to resolve the trigger condition via further reorientation relative to the same trigger condition, e.g., try further movement where the previous successful moving didn't resolve the trigger condition.

In some embodiments, method 600 can enable an exit condition between orienting segments. As an example, if the OAI indicates a sequence of rotations of an antenna array to improve RSSI above a threshold level, then a first rotation (transitioning the orientation of CPE from N to N+1) can result in a 75% RSSI that can be checked at 630 against a rule that is satisfied at 100% RSSI, whereby method 600 can pass to 640 where an exit condition is determined to occur where RSSI is 85% or higher. Accordingly, a next rotation can be undertaken via 642 and a second use of 620. The next example rotation (from N+1 to N+2) can cause an 90% RSSI. The 90% RSSI can again fail to satisfy the rule at 630, e.g., 90%<100%, and 600 can again pass to 640. With a 90% RSSI, the exit condition can be determined to have occurred, e.g., 90%>85% RSSI, and the method can return to 610. This example can illustrate granularization of reorienting operations, e.g., the reorienting can aim to achieve 100% RSSI in this example, but can truncate reorienting operations where better than 85% RSSI is achieved. It is noted that the example return to 610 at 90% RSSI can cause a subsequent trigger condition, for example, with finer grain RSSI targets via a next reorientation. As an example, the rule can relate to trying to achieve 100% RSSI within twenty smaller rotation steps, whereby the rule can count the number of either stop at 100% RSSI or 20 rotations, whichever occurs first. Where the further rotations result in less than 100% RSSI in this example, another subsequent trigger condition can cause reorientation to the highest measured RSSI among the twenty rotations. It is readily apparent that rules can be tailored to achieve different goals, for example a minimum performance, exploratory measurements, etc. Moreover, method 600 comprising an exit condition can avoid method 600 getting stuck in a loop where the rule(s) at 630 isn't satisfied. Moreover, in some embodiments, a rule at 630 can relate to an exit condition, whereby a method 600 can then proceed from 630 to 610, can proceed from 630 to 642 and then back to 620, and/or can continue to proceed from 630 to 640, 642, and 620.

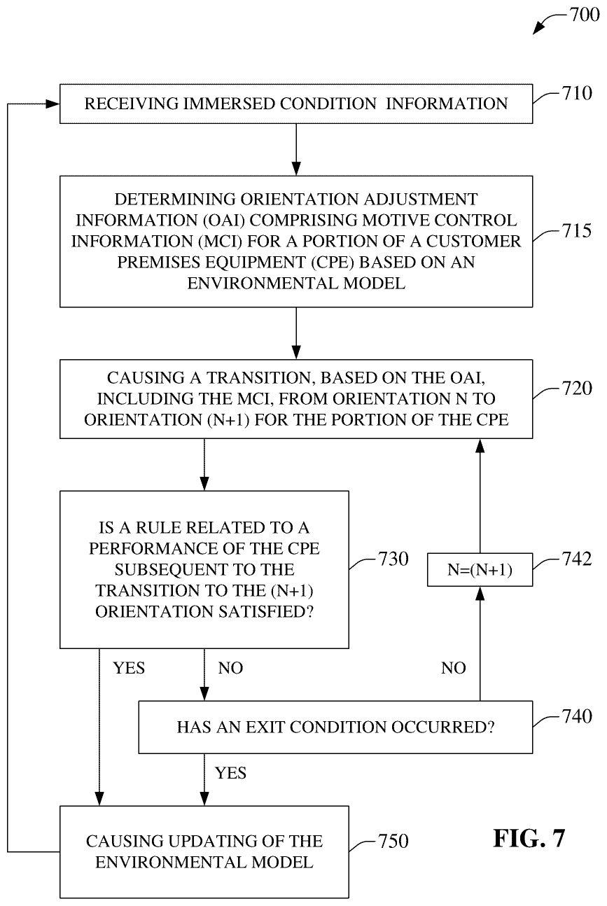

FIG. 7 illustrates example method 700 that facilitates automated orienting of customer premises equipment (CPE) by moving a portion of the CPE in accord with a model of a CPE environment, in accordance with aspects of the subject disclosure. Method 700, at 710, can comprise receiving immersed condition information that can indicate a condition of an environment in which the CPE is immersed. As an example, immersed condition information can indicate a drop in RSRP.

At 715, method 700 can comprise determining OAI for a portion of a CPE. OAI can comprise motive control information (MCI). The MCI can be based on an environmental model of an environment of the CPE. In embodiments, the determining OAI can be in response to determining an occurrence of a trigger condition from the immersed condition information received at 710. In an example, immersed condition information can indicate a drop in RSRP for a CPE in a first orientation. This drop in RSRP can cause method 700 to determine OAI, which can comprise MCI. The MCI can be based on a model of the customer premises, for example where changing an orientation of an antenna of the CPE can change a direction of peak antenna reception relative to modeled features of the customer premises, for example to avoid receiving transmissions through a thicker portion of a wall, the MCI can indicate rotation of the antenna based on a model of the CPE's position relative to the thicker portion of the wall. In another example, MCI can indicate driving the CPE to a different location in the room based on modeled furniture positions in the room.

At 720, method 700 can comprise, causing a transition from orientation N to orientation N+1 for the portion of the CPE. The causing the transition can be based on the OAI, including MCI, determined at 715. It is noted that reorientation can be accomplished via a sequence of transitions. In this example, N can be an initial position, and N+1 can be the position after a first reorientation segment, such that N+2 can be the position after a second reorientation segment, N+3 can be the position after a third reorientation segment, etc.

Method 700, at 730, can comprise determining that a rule related to a performance of the CPE subsequent to the transition of the N+1 orientation has been satisfied. Satisfaction of the rule at 730 can cause method 700 to advance to 750, where the environmental model can be updated, e.g., the model can be updated based on data gathered during reorienting. However, where the rule at 730 is not satisfied, method 700 can proceed to 740.

At 740, method 700 can determine if an exit condition has occurred. An exit condition can indicate that progression to the new orientation can be truncated. Where an exit condition has occurred, method 700 can advance to 750, where the environmental model can be updated, e.g., the model can be updated based on data gathered during reorienting, even where the reorienting was truncated. Where an exit condition does not occur, method 700 can increment N at 742 and return to 720 to cause a next segment of transition to occur. Method 700 can end at this point. Due to the incrementation of N, the next pass through 720 can cause a transition from N+1 to N+2, based on N=N+1 at 742. Returning to 710 can indicate successful reorienting that resolves a trigger condition determined from initial immersed condition information. Method 700 can then wait for subsequent immersed condition information and can determine if another trigger condition arises. As in method 600, where the successful reorienting does not resolve a trigger condition, a subsequent trigger can be caused, resulting in further reorientation attempts to resolve the same trigger condition, typically with alternative OAI and MCI.

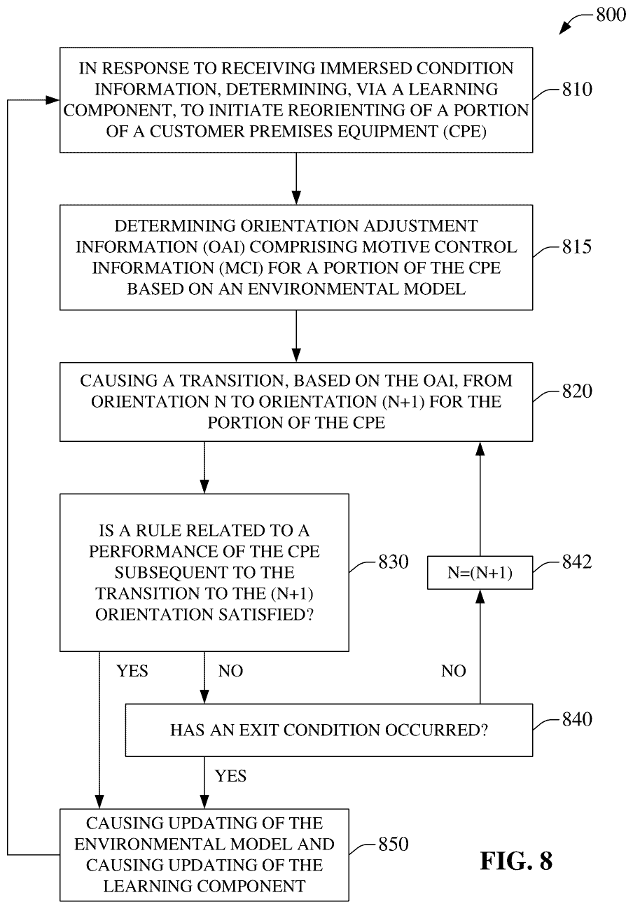

FIG. 8 illustrates example method 800 facilitating automated orienting of customer premises equipment (CPE) in response to a learning component initiating a reorienting of the CPE, in accordance with aspects of the subject disclosure. At 810, method 800 can comprise, in response to receiving immersed condition information that can indicate a condition of an environment in which the CPE is immersed, determining to initiate reorienting of a portion of a CPE. The determining can be performed via a learning component that can apply AI and/or ML techniques relative to the received immersed condition information. As an example, immersed condition information can indicate temperature of a room increasing. In this example, a learning component can predict that the increasing room temperature will lead to a thermal hazard for the CPE based on historical thermal information for the room, e.g., based on historical weather information, historical thermal change models for the room, historical thermal impacts on the CPE or other similar CPEs, etc., e.g., where the learning component can be taught that on a sunny July day (external weather informing) historically, when the room transitions 70 F by 9 a.m., the room will likely hit 95 F by 2 p.m., then where the immersed condition information indicates the room is 70 F at 8 a.m. on July 4th, then the learning component can predict that the room will be at 95 F by 2 p.m. on July 4th. This can permit the learning component to predictively cause reorienting triggers.

At 815, method 800 can comprise determining OAI for a portion of a CPE. OAI can comprise MCI that can be based on an environmental model of a CPE's environment. In embodiments, the determining OAI can be in response to determining an occurrence of a trigger condition, via the learning component, based on the immersed condition information received at 810. The MCI can be based on a model of the customer premises, for example where changing an position of the whole CPE to another room that historically stays cooler than the initial room, based on the above example, can result in some loss of signal strength but can be predicted to avoid thermal cycling of the CPE, based on the modeled features of the customer premises, this can be determined to be an acceptable mitigating strategy and the MCI can indicate driving information for the CPE to transition between the two rooms of the customer premises.

At 820, method 800 can comprise, causing a transition from orientation N to orientation N+1 for the portion of the CPE. As previously noted, reorienting, for example between two rooms, can be decomposed into reorienting segments, for example, moving to a doorway of the first room, moving down a hall, moving to a second doorway, moving to the far side of the second room, etc. Causing the transition(s) can be based on the OAI, including MCI, determined at 815. In this example, N can be an initial position in the first room, and N+1 can be the position at the first doorway, such that N+2 can be the position at the end of the hall, N+3 can be the position at the second doorway, N+4 can be the position at the far side of the second room, etc.

Method 800, at 830, can comprise determining that a rule related to a performance of the CPE subsequent to the transition of the N+1 orientation has been satisfied. Satisfaction of the rule at 830 can cause method 800 to advance to 850, where the environmental model can be updated, e.g., the model can be updated based on data gathered during reorienting. Moreover, the learning component can also be updated at 850. However, where the rule at 830 is not satisfied, method 800 can proceed to 840.

At 840, method 800 can determine if an exit condition has occurred. An exit condition can indicate that progression to the new orientation can be truncated. Where an exit condition has occurred, method 800 can advance to 850, where the environmental model and learning component can each be updated, e.g., the model and/or learning component can be updated based on data gathered during reorienting, even where the reorienting was truncated. Where an exit condition does not occur, method 800 can increment N at 842 and return to 820 to cause a next segment of transition to occur. Method 800 can end at this point. Due to the incrementation of N, the next pass through 820 can cause a transition from N+1 to N+2, based on N=N+1 at 842. Returning to 810 can indicate successful reorienting that resolves a trigger condition determined from initial immersed condition information. Method 800 can then wait for subsequent immersed condition information and can determine if another trigger condition arises. As in methods 600 and 700, where the successful reorienting does not resolve a trigger condition, a subsequent trigger can be caused, resulting in further reorientation attempts to resolve the same trigger condition, typically with alternative OAI and MCI.

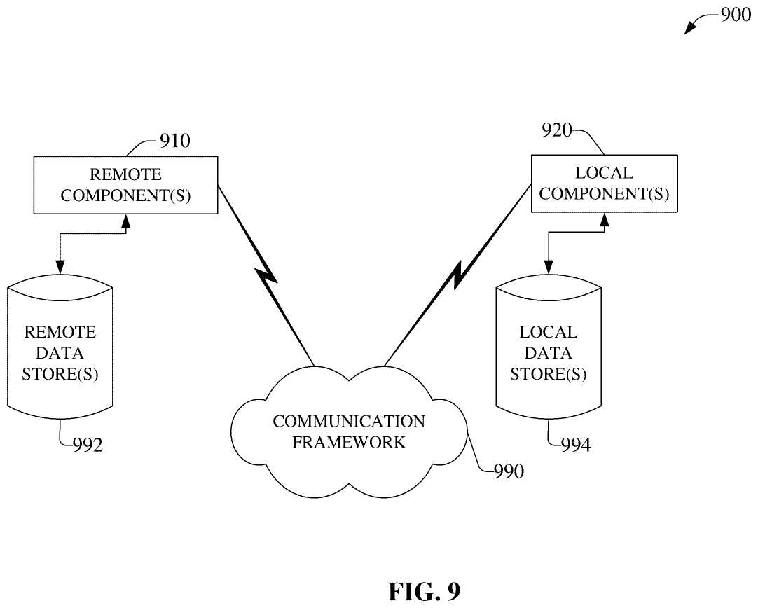

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can comprise RAN component 104-504, etc., communication framework 190, etc., measurement component 312, etc., CPE 110-510, etc., or any other component that is located remotely from another component of systems 100-500, etc.

The system 900 also comprises one or more local component(s) 920. The local component(s) 920 can be hardware and/or software (e.g., threads, processes, computing devices). In some embodiments, local component(s) 920 can comprise CPE 110-510, etc., orienting component 120-520, etc., immersed condition component 230-330, etc., environment modeling component 240-340, etc., measurement component 312, etc., learning component 322, etc., rule component 324, etc., CMC 350, etc., PCMC 360, etc., RAN component 104-504, etc., communication framework 190, etc., or any other component that is located local to another component of systems 100-500, etc. As one of many possible examples, an CPE 310 can comprise OC 320 that can be connected to a local measurement component 312 and a remotely located measurement component, whereby CPE 310 can facilitate communication between UE 302 and RAN component 304, and whereby CPE 310 can automatically reorient, via CMC 350 and/or PCMC 360, for example to improve KPIs, mitigate a hazard condition, adapt to a customer preference, etc.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 990 that can comprise path segments, path parts, etc., that can be employed to facilitate communications between the remote component(s) 910 and the local component(s) 920, and can comprise a fiber segment, metal segment, e.g., copper segment, etc., an air interface segment, e.g., Uu interface of a UMTS network, via a long-term evolution (LTE) network, 5G, 6G, and/or another path segment. Remote component(s) 910 can be operably connected to one or more remote data store(s) 992, such as a hard drive, solid state drive, SIM card, eSIM, device memory, etc., that can be employed to store information on the remote component(s) 910 side of communication framework 990. Similarly, local component(s) 920 can be operably connected to one or more local data store(s) 994, that can be employed to store information on the local component(s) 920 side of communication framework 990. As examples, environmental model information for a customer premises can be communicated from a remotely located profile to a CPE, whereby the CPE can determine orientation information based on the model information; network topography information can be communicated to CPE form a network provider, enabling CPE to determine orientation information relative to a RAN component proximate to a customer premises; weather information can be received from an external source to enable a CPE learning component to predict a trigger condition and proactively determine orientation information to mitigate possible hazard conditions for a CPE; etc.

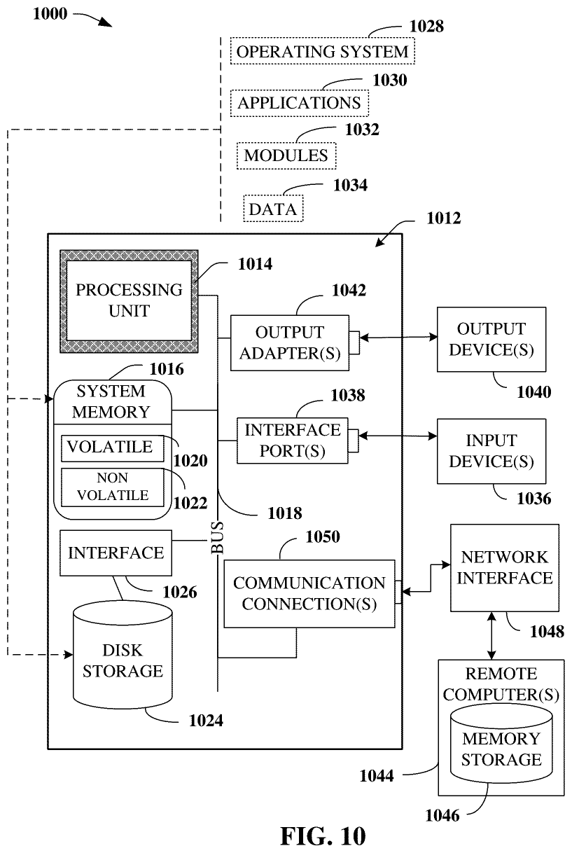

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random-access memory, double data rate synchronous dynamic random-access memory, enhanced synchronous dynamic random-access memory, SynchLink dynamic random-access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can, for example, be comprised in, or can comprise, CPE 110-510, etc., orienting component 120-520, etc., immersed condition component 230-330, etc., environment modeling component 240-340, etc., measurement component 312, etc., learning component 322, etc., rule component 324, etc., CMC 350, etc., PCMC 360, etc., RAN component 104-504, etc., communication framework 190, etc., or any other component of systems 100-500, etc., can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random-access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory, or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory, or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries, or other data retrieval protocols, for a variety of operations with respect to the information stored by the medium. As such, for example, a computer-readable medium can comprise executable instructions stored thereon that, in response to execution, can cause a system comprising a processor to perform operations comprising in response to receiving condition information corresponding to a condition of an environment applicable to customer premises equipment, determining that a trigger criterion has been satisfied based on the condition information, and in response to the determining that the trigger criterion has been satisfied, determining orientation adjustment information for a portion of the customer premises equipment based on the condition information, and causing reorientation of the portion of the customer premises equipment based on the orientation adjustment information.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line-controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring, and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “eNodeB,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can comprise packetized or frame-based flows. Data or signal information exchange can comprise technology, such as, single user (SU) multiple-input and multiple-output (MIMO) (SU MIMO) radio(s), multiple user (MU) MIMO (MU MIMO) radio(s), long-term evolution (LTE), fifth generation partnership project (5G or 5GPP); sixth generation partnership project (6G or 6GPP), next generation (NG) radio, LTE time-division duplexing (TDD), global system for mobile communications (GSM), GSM EDGE Radio Access Network (GERAN), Wi Fi, WLAN, WiMax, CDMA2000, LTE new radio-access technology (LTE-NX), massive MIMO systems, etc.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to authenticating a user-identity to a user-account. Authentication can, in some embodiments, refer to determining whether a user-identity requesting a service from a telecom network is authorized to do so within the network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); sixth generation partnership project (6G or 6GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (X) for millimeter waves is typically in the 1-mm to 10-mm range.

The term “infer”, or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations, comprising:
determining, in response to detecting an occurrence of a trigger condition, orientation adjustment information for a portion of a customer premises equipment, and
initiating a transition from a first orientation of the portion of the customer premises equipment to a second orientation of the portion of the customer premises equipment, wherein the transition is based on the orientation adjustment information.

2. The device of claim 1, wherein the orientation information is based on a model of an environment corresponding to the customer premises equipment.

3. The device of claim 1, wherein the orientation information is based on a condition of an environment experienced by the customer premises equipment.

4. The device of claim 3, wherein the condition is a thermal condition.

5. The device of claim 3, wherein the condition is a radio frequency signal attenuation condition.

6. The device of claim 3, wherein the condition is a radio frequency signal interference condition.

7. The device of claim 6, wherein the condition is a customer placement condition corresponding to a placement of the customer premises equipment by a customer.

8. The device of claim 1, wherein the transition from the first orientation to the second orientation comprises the transition of all of the customer premises equipment to the second orientation.

9. The device of claim 1, wherein the transition from the first orientation to the second orientation comprises the transition of less than all of the customer premises equipment to the second orientation.

10. The device of claim 1, wherein the transition from the first orientation to the second orientation comprises a first transition of all of the customer premises equipment to a third orientation and a second transition of the portion less than all of the customer premises equipment to a fourth orientation.

11. The device of claim 1, wherein the transition from the first orientation to the second orientation comprises a change in a degree of freedom of the portion of the customer premises equipment, and wherein the degree of freedom is selected from a group of degrees of freedom comprising roll, pitch, yaw, x-axis skew, y-axis skew, and z-axis skew.

12. The device of claim 1, wherein the portion of the customer premises equipment is selected from a group of portions comprising a heat shield portion of the customer premises equipment, an antenna portion of the customer premises equipment, and an antenna mast portion of the customer premises equipment.

13. The device of claim 1, wherein the operations further comprise:
initiating exploratory reorienting of the portion of the customer premises equipment enabling collection of information that is employed to update a model of an environment corresponding to the customer premises equipment, the exploratory reorienting resulting in an updated model of the environment corresponding to the customer premises equipment, wherein the trigger condition is detected based on the updated model of the environment.

14. A method, comprising:
receiving, by a system comprising a processor, condition information corresponding to a condition of an environment in which customer premises equipment is situated;
determining, by the system, that an occurrence of a trigger condition has taken place based on analysis of the condition information;
determining, by the system and in response to the occurrence of the trigger condition, orientation adjustment information for a portion of the customer premises equipment based on the condition information; and
automating, by the system, orienting the portion of the customer premises equipment based on the orientation adjustment information.

15. The method of claim 14, wherein determining the orientation adjustment information is further based on an updateable model of the environment of the customer premises equipment, and wherein the updateable model is updatable based on interrogation of the environment by the customer premises equipment.

16. The method of claim 14, wherein automating the orienting of the portion of the customer premises equipment results in changing an orientation of all portions of the customer premises equipment.

17. The method of claim 14, wherein automating the orienting of the portion of the customer premises equipment results in additively changing a first orientation of the portion of the customer premises equipment and changing a second orientation of all portions of the customer premises equipment.

18. A non-transitory machine-readable medium, comprising executable instructions that, when executed by a processor, facilitate performance of operations, comprising:
in response to receiving condition information corresponding to a condition of an environment applicable to customer premises equipment, determining that a trigger criterion has been satisfied based on the condition information,
in response to the determining that the trigger criterion has been satisfied, determining orientation adjustment information for a portion of the customer premises equipment based on the condition information, and
causing reorientation of the portion of the customer premises equipment based on the orientation adjustment information.

19. The non-transitory machine-readable medium of claim 18, wherein the reorientation of the portion of the customer premises equipment results in changing an orientation of the entire customer premises equipment.

20. The non-transitory machine-readable medium of claim 18, wherein the reorientation of the portion of the customer premises equipment is based on changing a first orientation of the portion of the customer premises equipment and concurrently changing a second orientation of the entire customer premises equipment.
